(19) United States
(12) Patent Application Publication
(10) Pub. No.: US 2016/0210033 A1
(43) Pub. Date: Jul. 21, 2016

(54) Remote Support of a Device

(71) Applicant: HEWLETT-PACKARD DEVELOPMENT COMPANY, L.P., Houston, TX (US)

(72) Inventors: ERIC GAGNERAUD, PALO ALTO, CA (US); HERVE GILBERT, HOUSTON, TX (US); CESAR AUGUSTO ROSA, HOUSTON, TX (US); STEPHEN M DeROOS, VANCOUVER, WA (US)

(21) Appl. No.: 14/911,280

(22) PCT Filed: Oct. 9, 2013
(86) PCT No.: PCT/US2013/064045

§ 371 Date: Feb. 10, 2016

(51) Int. Cl. G06F 3/0484; H04L 29/08; G06F 17/22

(52) U.S. Cl. CPC G06F 3/04847; G06F 17/2235; G06F 3/0484; H04L 67/025

(57) ABSTRACT

A support tool is received by a first device from a second device. In a user interface at the first device, information is presented regarding a context of the first device, an issue at the first device, a solution for the issue, and a link to a resource to assist in addressing the issue.

### BACKGROUND

Users of electronic devices may experience various issues with their electronic devices. A user may contact technical support personnel of an organization to address an issue with the user's electronic device. The organization may be the organization that sold the electronic device, or alternatively, the organization may be an organization contracted to provide service for electronic devices.

### BRIEF DESCRIPTION OF THE DRAWINGS

Some implementations are described with respect to the following figures.

FIG. 1 is a block diagram of an example arrangement that includes an agent device and a customer device, according to some implementations.

FIG. 2 is a flow diagram of a customer device process according to some implementations.

FIG. 3 is a flow diagram of an agent device process according to some implementations.

FIGS. 4-6 are schematic diagrams of various graphic user interface (GUI) screens provided by a support tool according to some implementations.

FIG. 7 is a block diagram of an example computer system according to some implementations.

### DETAILED DESCRIPTION

When contacted, a support agent may be able to remotely connect to an electronic device. Traditionally, the support agent performs manual actions in attempting to identify what the issue is and to determine a solution to the issue at the electronic device.

Manual actions performed by a support agent in remotely diagnosing an issue at an electronic device may be time consuming. Increased support time can lead to increased costs (to the support organization or to a customer), and may lead to customer dissatisfaction. A support agent can refer to any person that is able to remotely access an electronic device over a network to address an issue at the electronic device. Examples of electronic devices include any or some combination of the following: notebook computers, desktop computers, tablet computers, personal digital assistants (PDAs), smartphones, game appliances, television set top boxes, and so forth.

Examples of issues that can be present in an electronic device include any or some combination of the following: failure or fault of machine-readable instructions (e.g. software or firmware), failure of fault of hardware components, incorrect settings of machine-readable instructions or hardware components, absence of a component that prevents proper electronic device operation, failure to upgrade to a latest version of machine-readable instructions, and so forth.

Different electronic devices may have different components, such as different operating systems, different applications, different types of hardware components (e.g. processors, memory devices, network interface controllers, graphics controllers, etc.), different customized settings, different peripheral devices connected to the electronic devices, and so forth. Examples of settings that may be different across different electronic devices include settings relating to machine-readable instructions (e.g. operating system, device driver, application, etc.), security-related settings, update settings relating to updates of machine-readable instructions, and so forth.

As a result, the process of gathering information relating to the context of an electronic device can be time consuming if performed manually. The context of the electronic device can refer to an environment of the electronic device, where the environment can include the type of operating system in the electronic device, the types of hardware components in the electronic device, settings of the electronic device, peripheral devices connected to the electronic device, and so forth. Moreover, in view of the different contexts of different electronic devices, support agents may find the processing of diagnosing and providing solutions to issues challenging.

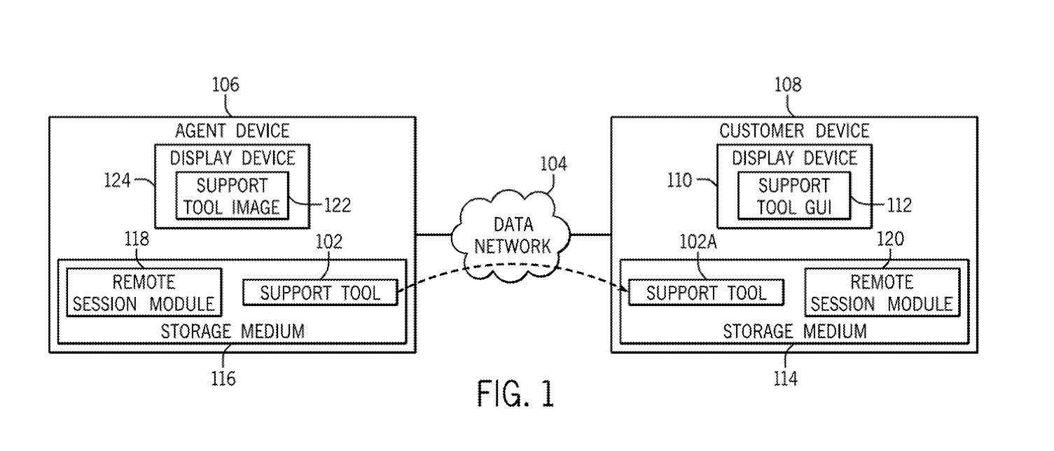

In accordance with some implementations, as shown in FIG. 1, a support tool 102 can be loaded over a data network 104 from an agent device 106 to a customer device 108. Examples of a data network 104 can include the Internet, a private network, or any other type of network. The data network 104 can be a wired network, a wireless network, or some combination of a wired and wireless networks.

Each of the agent and customer devices 106 and 108 can be any type of electronic device that can communicate over the data network 104. The agent device 106 can be an electronic device that is used by a support agent at an organization that services customer devices. The agent device 106 can be one of multiple agent devices associated with respective support agents at a support center of the organization.

The loaded version of the support tool 102 at the customer device 108 is referenced as 102A. The loaded support tool 102A is executable in the customer device 108, and upon execution, the support tool 102A can present a support tool graphical user interface (GUI) 112 at a display device 110 of the customer device 108. The support tool 102A can be stored in a storage medium 114 of the customer device 108. The support tool 102A can be loaded for execution on one or more multiple processors (not shown in FIG. 1) in the customer device 108.

At the agent device 106, the support tool 102 is stored in a storage medium 116 of the agent device 106. The storage medium 116 can also store a remote session module 118, which is able to establish a remote session between the agent devices 106 and 108. The storage medium 114 in the customer device 108 also stores a remote session module 120 that is able to cooperate with the remote session module 118 in the agent device 106 to establish the remote session.

Establishment of the remote session between the agent device 106 and the customer device 108 allows for communications to be performed between the devices. Such communications can include loading of the support tool 102 from the agent device 106 to the customer device 108.

The communications in the remote session can also include sending an image of screens of the support tool GUI 112 from the customer device 108 to the agent device 106. This image received from the customer device 108 can be displayed as a support tool image 122 at a display device 124 of the agent device 106.

Note that the support tool (more specifically, the loaded support tool 102A) executes in the customer device 108 rather than at the agent device 106. The support tool image 122 displayed at the agent device 106 is a copy of the support tool GUI screen displayed at the customer device 108. In this manner, the tasks of the support tool are performed at the customer device 108, where the tasks can include gathering information relating to the context of the customer device 108, identifying an issue at the customer device 108, determining a solution to the issue, and providing links to local resources, remotely provided resources for local execution, and/or remote resources to further assist in solving the issue.

In the remote session, the support agent (at the agent device 106) is also able to interact with various interactive features of the support tool GUI 112 (displayed at the customer device 108) by making user input selections with respect to the support tool image 122 displayed at the agent device 106. Any user input selection made with respect to the support tool image 122 at the agent device 106 is communicated over the data network 104 by the remote session module 118 to the remote session module 120, and the user input selection is communicated by the remote session module 120 to the support tool 102A at the customer device 108. The support tool 102A is able to respond to the user input selection made by the support agent to perform a requested task.

As noted above, the support tool 102A is able to obtain context information about the context of the customer device 108. In addition, the support tool 102A is able to identify an issue at the customer device 108 and present a solution to the issue. The context information, identified issue, and solution to the issue can be presented in one or multiple screens of the support tool GUI 112 at the customer device 108.

The customer device 108 can also present various links in the support tool GUI 112, where the links can include links to local resources and/or links to remote resources. Local resources can include any or some combination of the following: features of the operating system at the customer device 108, a pre-installed diagnostic tool at the customer device 108 invocable to perform diagnostic tasks to determine the presence or determine solutions to certain issues in the customer device 108, a third party application that can be invoked to assist in determining a solution to an issue, a remotely delivered executable code to be executed locally, and so forth. Examples of remote sources include a website accessible to obtain additional information, an external tool that can be loaded to the customer device 108, and so forth.

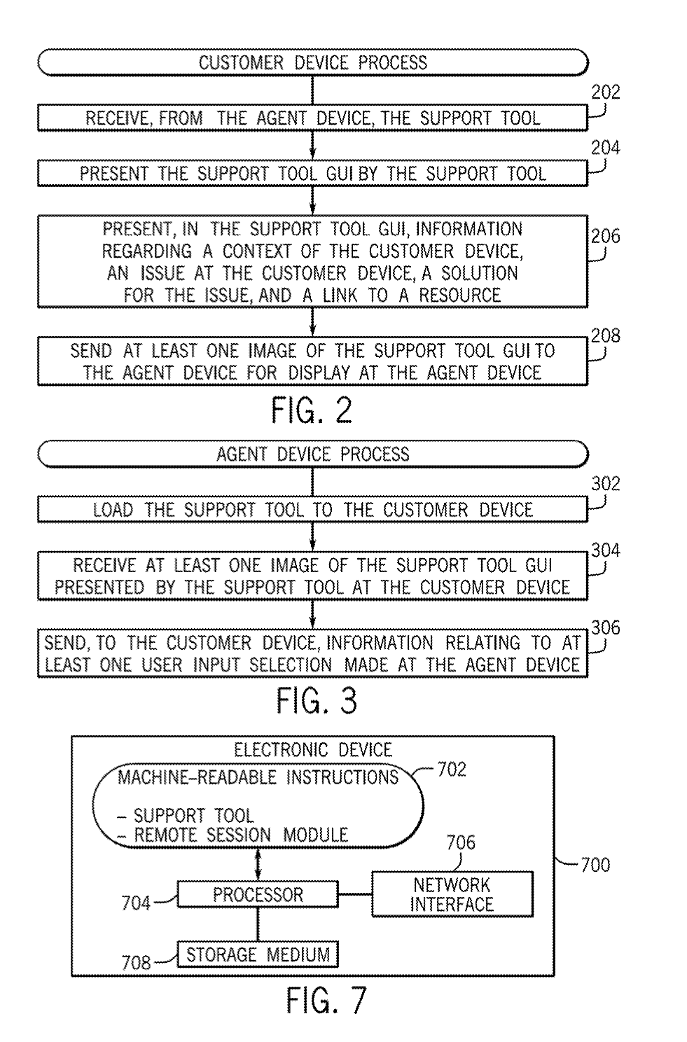

FIG. 2 is a flow diagram of a customer device process that is performed at the customer device 108, in accordance with some implementations. The customer device process receives (at 202), from the agent device 106, the support tool 102A. Upon execution of the support tool 102A at the customer device 108A, the customer device process presents (at 204) the support tool GUI 112.

The customer device process presents (at 206), in the support tool GUI 112 at the display device 110 of the customer device 108, information regarding a context of the customer device 108, an issue at the customer device 108, a solution for the issue, and a link to a resource to assist in addressing the issue. The link to the resource can be a link to a local resource, or a link to a remote resource, or both.

The customer device process further sends (at 208) at least one image of the support tool GUI 112 to the agent device 106 for display at the agent device 106 as the support tool image 122 depicted in FIG. 1. The support tool image 122 at the agent device 106 includes the various presented information at the support tool GUI 112 displayed at the customer device 108.

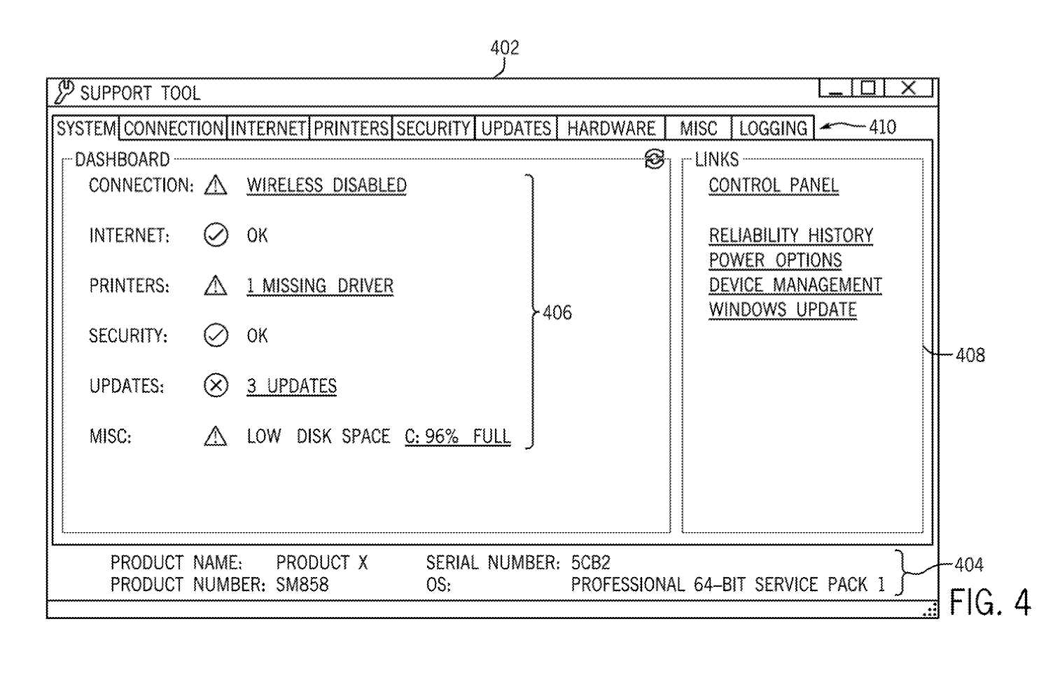

FIG. 3 is a flow diagram of an agent device process that is performed at the agent device 106, in accordance with some implementations. To allow for remote support actions to be performed at the customer device 108, the agent device 106 first establishes a remote session with the customer device 108. The remote session can be established using the remote session modules 118 and 120 of FIG. 1. Once the remote session is established, the agent device process loads (at 302) the support tool 102 to the customer device 108, for execution at the customer device 108.

The agent device process receives (at 304) at least one image of the support tool GUI 112 presented by the support tool 102A executing at the customer device 108. The received at least one image is presented as the support tool image 122 in the display device 124 of the agent device 106. The support tool image 122 includes various information that is presented at the support tool GUI 112 displayed at the display device 110 of the customer device 108.

The agent device process sends (at 306), to the customer device 108, information relating to at least one user input selection made at the agent device 106 with respect to the support tool image 122. For example, various selectable icons or elements of the support tool GUI 112 can be displayed in the support tool image 122. These selectable icons or elements cause the support tool 102A to perform various functions or obtain certain information at the customer device 108.

A support agent can activate a user input device (e.g. mouse device, touchscreen device, keyboard, etc.) at the agent device 106 to make selections with respect to such selectable icons or elements that are displayed in the support tool image 122. The information relating to the at least one user input that is sent to the customer device 108 invokes an action of the support tool 102A at the customer device 108.

The following describes various examples of support tool GUI screens that can be presented by the support tool 102A executing at the customer device 108 of FIG. 1. Note that the support tool GUI screens are provided for purposes of example. In other examples, other types of support to GUI screens can be provided.

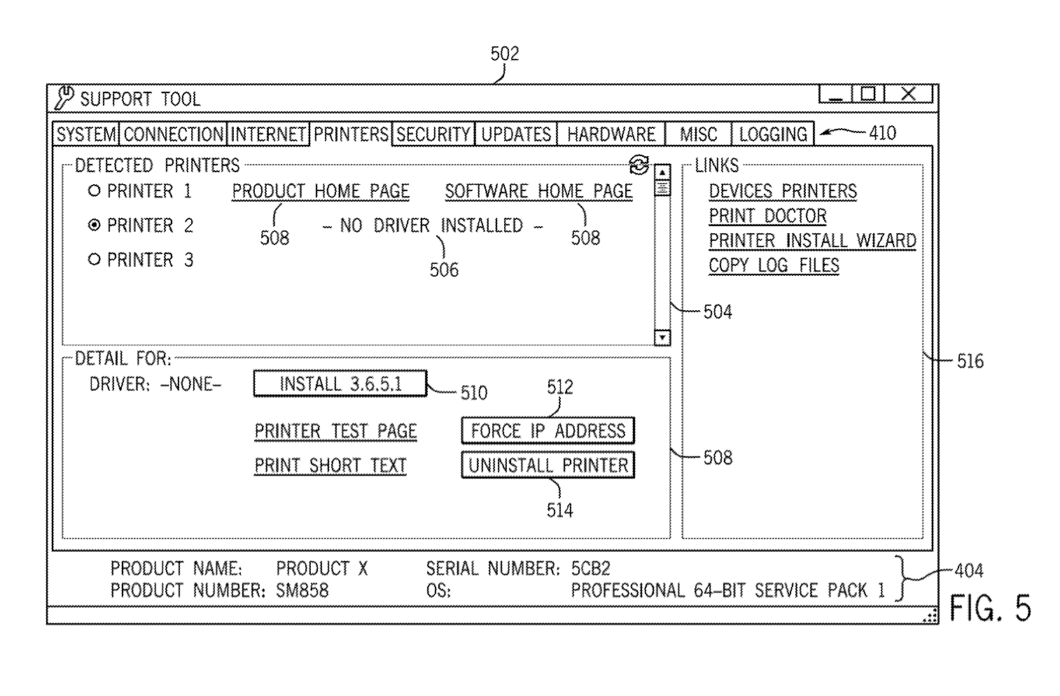

A system screen 402 is depicted in FIG. 4, which presents various examples of overview information that can be presented in the support to GUI 112. The system screen 402 includes various context information 404, including a product name, a serial number, a product number, and a type of operating system. In other examples, the context information 404 can include additional or alternative information.

The system screen 402 can also include a dashboard region 406 that has several entries that contain status information regarding various components of the customer device 108. In the example of FIG. 4, the entries of the dashboard region 406 include an entry relating to status information of the connection of the customer device 108, an entry relating to the status of Internet access, an entry relating to status of printers accessible by the customer device 108, an entry relating to a security status of the customer device 108, an entry relating to a status of updates at the customer device 108, and an entry relating to a status of storage space at the customer device 108.

In the example of FIG. 4, the status information in the dashboard region 406 indicates various issues of the customer device 108. These issues include the wireless interface being disabled, a printer driver missing, updates that have not yet been performed, and low storage space. By aggregating the presentation of multiple issues in the dashboard region 406, the support agent can more easily identify all such issues that may have to be resolved.

The system screen also includes a links region 408, which includes various links that are selectable for accessing features of an operating system or other features of the customer device 108. Accessing features of the customer device 108 may be challenging due to differences between components of different customer devices. The links region 408 provides a convenient mechanism to allow the remote support agent to seamlessly access various features of the customer device 108, without the remote support agent having to manually determine the context of the customer device 108.

The system screen 402 also includes various tabs 410 that are user selectable. In the example of FIG. 4, the “System” tab is selected to cause the content of the system screen 402 to be presented. A user (such as a remote support agent) can select other ones of the tabs 410 to cause different support tool GUI screens to be displayed.

Although various example elements are shown in the system screen 402, it is noted that in other examples, some of the elements may be omitted, or alternative elements may be included.

FIG. 5 shows a printers screen 502 that is presented in response to selection of the “Printers” tab. For example, the remote support agent may have selected the “Printers” tab in response to seeing the printer issue in the dashboard region 406 of the system screen 402 of FIG. 4. The printers screen 402 includes a region 504 that identifies one or multiple detected printers accessible by the customer device 108. In the example of FIG. 5, the region 504 identifies “Printer 2” as being accessible by the customer device 108. The region 504 also includes status information 506 associated with the identified printer(s). In the example of FIG. 5, the status information 506 indicates that no driver is installed for Printer 2.

In addition, user-selectable links 508 are presented in the region 504. The user-selectable links are links to remote resources, such as websites corresponding to the specific printer product or to a software associated with the printer product. If one of the user-selected links 508 is selected by the remote support agent, then a web page corresponding to the selected link can be loaded to the customer device 108. The web page can include information relating to the printer product or to the software associated with the printer product.

Another region 508 of the printer screen 502 includes various control elements that are selectable by the remote support agent to perform various tasks. The tasks can include tasks relating to a solution to the printer issue. For example, an “Install” button 510 can be selected to cause installation of the missing printer driver. Other control buttons 512 and 514 can be selected to perform other tasks that may be part of a solution to the printer issue.

The printer screen 502 also includes a links region 516 that includes various user-selectable links to other resources, which can be auxiliary tools that can be used in solving the printer issue. In some cases, to troubleshoot a specific issue, a support agent may have to install an auxiliary tool that is not present on the customer device 108. In this case, the support agent can remotely connect to a remote resource, load the auxiliary tool, and install the auxiliary tool in the customer device 108. The support tool 102A is able to automate the process of determining whether the auxiliary tool is already present in the customer device 108. The auxiliary tool is loaded from the remote source only if the auxiliary tool is not already present in the customer device 108.

During a remote session between the agent device 106 and the customer device 108, various support actions performed by the support agent on the customer device 108 can be logged by the support tool 102A executing in the customer device 108. Traditionally, the logging of actions may be performed manually by a support agent, which can be time consuming and error prone. For example, a support agent may omit certain actions from the log, or different support agents may log actions differently. To address the foregoing issue, the support tool 102A is able to automatically log various actions performed on the customer device 108. The logged actions can be communicated to a reporting system, which can be used for auditing, quality control, or other purposes.

An example of a logging screen 602 is shown in FIG. 6, in response to selection of the “Logging” tab. As support actions are performed by the support tool 102A and/or the support agent, text corresponding to the support actions can be added to log entry 604. If support actions are performed on multiple different days, then tabs 606 can be presented, where the different tables 606 are selectable to view logged actions on different days.

By using a support tool according to some implementations, remote support of a customer device is made more convenient and less time consuming. This can lead to both support agent and customer satisfaction. Also, service cost can be reduced. In some implementations, the support tool is able to retrieve context information of a customer device. The support tool is also able to check for issues of the customer device, and to present solutions to identified issues. Links to local and/or remote resources can also be provided to allow access of additional information and/or tools. Automatic logging can be performed in some implementations.

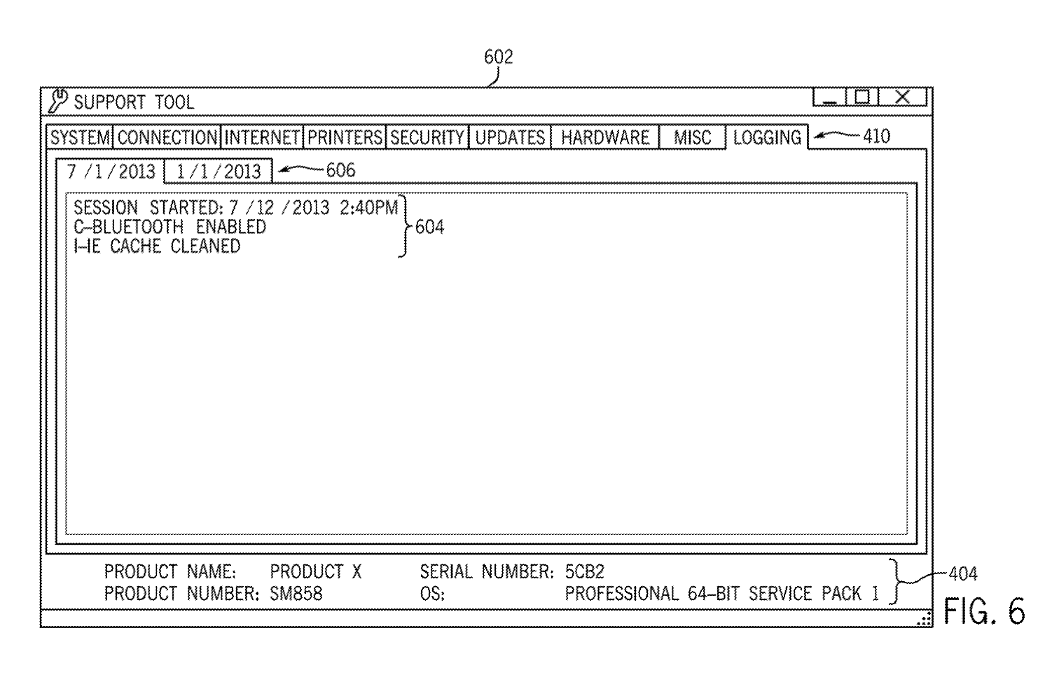

FIG. 7 is a block diagram of an example electronic device 700, which can be either the agent device 106 or a customer device 108 of FIG. 1. The electronic device 700 includes machine-readable instructions 702, which can include the support tool 102 or 102A, and a remote session module 118 or 120, as examples. The machine-readable instructions 702 are executable on one or multiple processors 704, which can be coupled to a network interface 706 and a storage medium (or storage media) 708. A processor can include a microprocessor, microcontroller, processor module or subsystem, programmable integrated circuit, programmable gate array, or another control or computing device. The network interface 706 allows the electronic device 700 to communicate over a data network, such as data network 104.

The storage medium (or storage media) 708 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be loaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method of providing remote support, comprising:
receiving, by a first device from a second device over a network, a support tool;
presenting, at the first device, a user interface provided by the support tool;
presenting, in the user interface at the first device, information regarding a context of the first device, an issue at the first device, a solution for the issue, and a link to a resource to assist in addressing the issue; and
sending, by the first device, at least one image of the user interface to the second device for display at the second device, the at least one image containing the presented information.

2. The method of claim 1, wherein presenting the information regarding the link to a resource comprises presenting the information regarding a link to a local resource in the first device.

3. The method of claim 2, further comprising:
receiving selection of the link to the local resource, wherein the received selection is responsive to an input by an agent at the second device made with respect to the at least one image; and
accessing the local resource in response to the received selection.

4. The method of claim 3, wherein accessing the local resource comprises accessing at least one selected from among a feature of an operating system in the first device, a feature of an application in the first device, and a pre-installed diagnostic tool in the first device.

5. The method of claim 1, wherein presenting the information regarding the link to a resource comprises presenting the information regarding a link to a remote resource accessible over the network by the first device.

6. The method of claim 5, further comprising:
receiving selection of the link to the remote resource, wherein the received selection is responsive to an input by an agent at the second device made with respect to the at least one image; and
accessing the remote resource over the network in response to the received selection.

7. The method of claim 6, wherein accessing the remote resource comprises accessing at least one selected from among a website and a remote tool loadable to the first device.

8. The method of claim 1, wherein presenting the information regarding the context of the first device comprises presenting information relating to an operating system in the first device, information relating to an electronic component in the first device, information relating to a peripheral device connected to the first device, and information relating to a setting of the first device.

9. The method of claim 1, further comprising:
logging, by the support tool in the first device, actions of the support tool and actions of a support agent at the second device.

10. An article comprising at least one non-transitory machine-readable storage medium storing instructions for providing remote support of a customer device, the instructions upon execution cause an agent device to:
load a support tool over a network to the customer device, the loaded support tool executable on the customer device;
receive at least one image of a user interface presented by the loaded support tool executing on the customer device, the at least one image containing information regarding a context of the customer device, an issue at the customer device, a solution for the issue, and a link to a resource to assist in addressing the issue; and
send, to the customer device, information relating to at least one user input made at the agent device with respect to the at least one image, the information relating to the at least one user input to invoke an action of the loaded support tool at the customer device.

11. The article of claim 10, wherein the instructions upon execution cause the agent device to display the at least one image in a display device of the agent device, wherein the at least one image is a copy of at least one graphical user interface screen presented by the support tool executing in the customer device.

12. A first device comprising:
a network interface to communicate over a network with a second device; and
at least one processor to:
execute a support tool loaded from the second device to provide remote support of the first device;
present a graphical user interface by the support tool, the graphical user interface including information regarding a context of the first device, an issue at the first device, a solution for the issue, and a link to a resource to assist in addressing the issue; and
send, through the network interface, at least one image of the graphical user interface to the second device for display at the second device, the at least one image containing the information in the graphical user interface.

13. The first device of claim 12, wherein the support tool is executable on the at least one processor to further:
receive a user input selection made at the second device with respect to the at least one image displayed at the second device; and
in response to the user input selection, access an auxiliary tool to assist in solving the issue.

14. The first device of claim 13, wherein the support tool is executable on the at least one processor to further:
in response to the user input selection, load the auxiliary tool from a remote source in response to determining that the auxiliary tool is not present in the first device.

15. The first device of claim 12, wherein the support tool is executable on the at least one processor to further:
receive a user input selection made at the second device with respect to the at least one image displayed at the second device; and
in response to the user input selection, access a website to obtain further information relating to the issue.
